(19) United States
(12) Patent Application Publication
(10) Pub. No.: US 2012/0126068 A1
(43) Pub. Date: May 24, 2012

(54) Handle For Retaining A Cable Of An Electronic Device

(75) Inventors: Timothy A. Meserth, Durham, NC (US); Gerard F. Muenkel, Raleigh, NC (US); Jared E. Schott, Apex, NC (US)

(73) Assignee: INTERNATIONAL BUSINESS MACHINES CORPORATION, Armonk, NY (US)

(21) Appl. No.: 12/949,039

(22) Filed: Nov. 18, 2010

(51) Int. Cl. F16L 3/08; B25G 1/00

(52) U.S. Cl. 248/65; 16/110.1

(57) ABSTRACT

Apparatuses that include a handle for retaining a cable of an electronic device are provided. In one embodiment, the handle includes a handle body that has first and second opposed ends, wherein each end of the handle body is fastened to the electronic device; and a plurality of cable grips that extend from a position on the handle body between the first and second opposed ends of the handle body, wherein the plurality of cable grips define a cable cavity that is contoured to partially house a cable of the electronic device.

### BACKGROUND OF THE INVENTION

1. Field of the Invention

The field of the invention is data processing, or, more specifically, apparatuses that include a handle for retaining a cable of an electronic device.

2. Description Of Related Art

Electronic devices often include cables that are disconnectable. In many instances, however, disconnection of the cable from the electronic device is unintentional. Typically, unintentional disconnection of a cable has negative consequences for a user of the electronic device. Applying cable retention mechanisms to the cable or to the electronic device may reduce the occurrence of unintentional disconnections of the cable.

### SUMMARY OF THE INVENTION

Apparatuses that include a handle for retaining a cable of an electronic device are provided. In one embodiment, a handle includes a handle body that has first and second opposed ends, wherein each end of the handle body is fastened to the electronic device; and a plurality of cable grips that extend from a position on the handle body between the first and second opposed ends of the handle body, wherein the plurality of cable grips define a cable cavity that is contoured to partially house a cable of the electronic device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth a diagram of an apparatus that includes a handle for retaining a cable of an electronic device according to embodiments of the present invention.

FIG. 1B sets forth an alternative view of the apparatus of FIG. 1A that includes a handle for retaining a cable of an electronic device according to embodiments of the present invention.

FIG. 1C sets forth an alternative view of the apparatus of FIG. 1A that includes a handle for retaining a cable of an electronic device according to embodiments of the present invention.

### DETAILED DESCRIPTION OF EXEMPLARY EMBODIMENTS

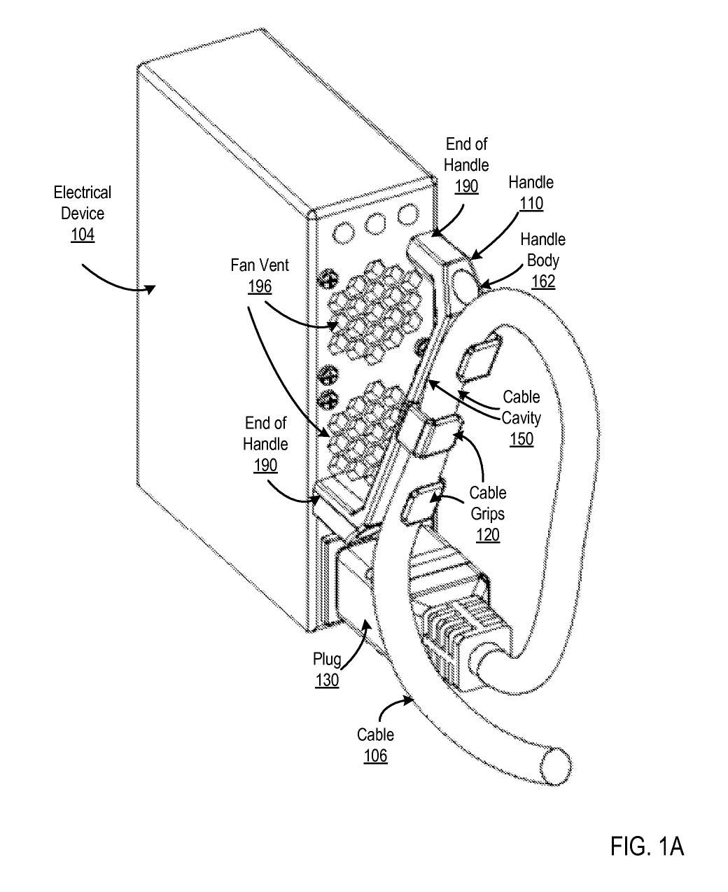

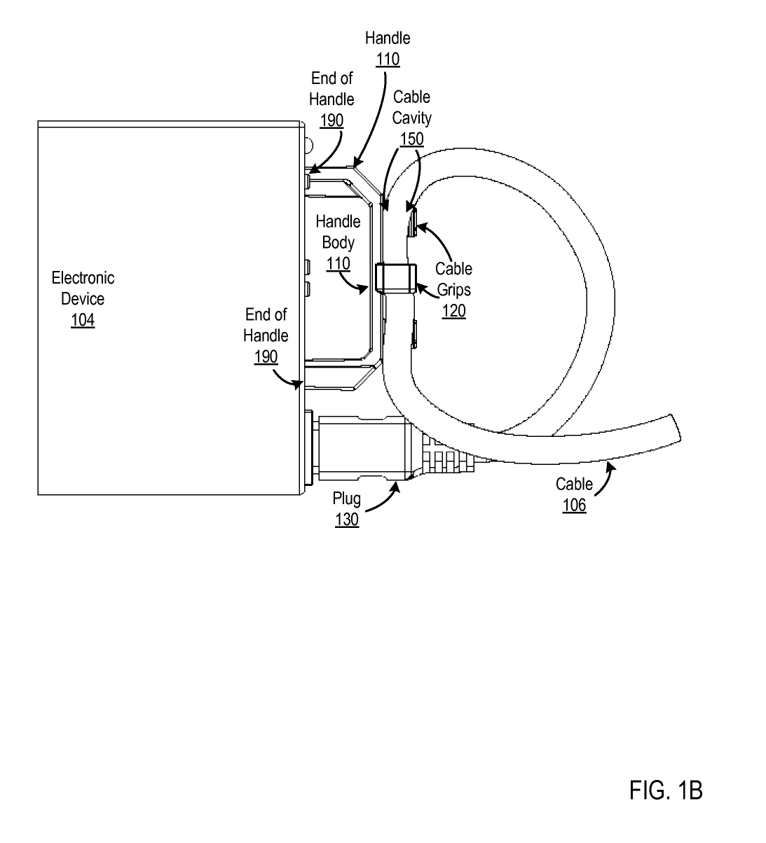

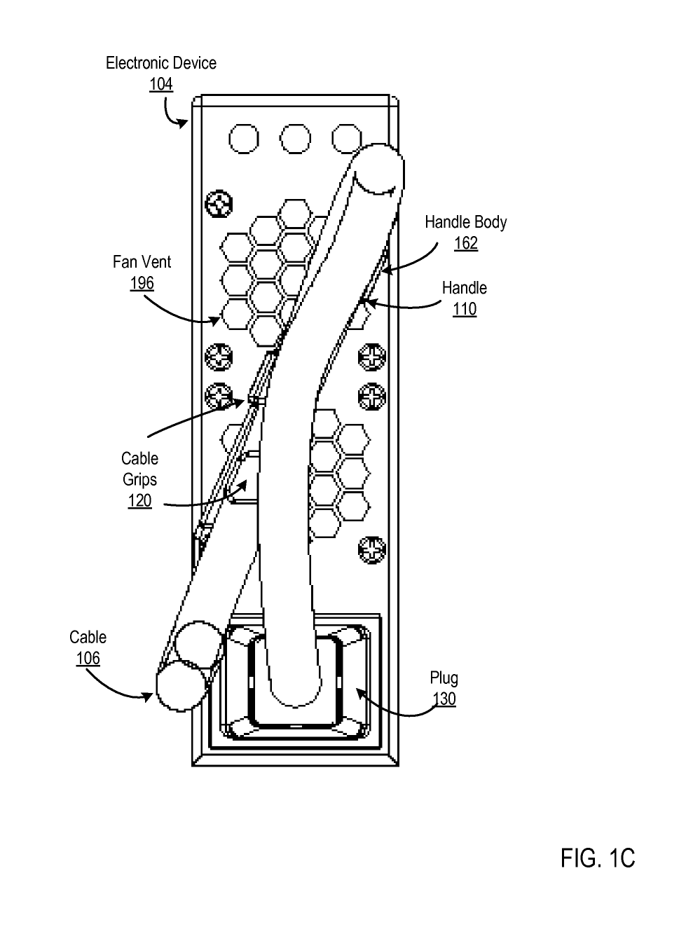

Exemplary apparatuses that include a handle for retaining a cable of an electronic device in accordance with the present invention are described with reference to the accompanying drawings, beginning with FIG. 1A. FIG. 1A sets forth a diagram of an apparatus that includes a handle (110) for retaining a cable (106) of an electronic device (104) according to embodiments of the present invention.

The electronic device (104) of FIG. 1A may be a power supply device. A power supply device is an electrical device that supplies electrical energy to one or more electrical loads. An example of the electrical device (104) of FIG. 1 may be a blade server power supply device that provides power to components of a blade server chassis, such as a blade center, a data communications network router, a patch panel, a Redundant Array of Independent Disks (RAID), a power strip, and so on.

Attached to the back of the electronic device (104) of FIG. 1A is the handle (110). The handle (110) of FIG. 1A includes a handle body (162) that has first and second opposed ends (190). Each end (190) of the handle body (162) is fastened to the electronic device (104). The ends (190) of the handle body (162) may be fastened to the electronic device (104) with screws or any other type of connector that can secure two ends of a handle as will occur to those of skill in the art. When the ends (190) of the handle body (162) are secured to the electronic device (104), the handle (110) may be used to move the electronic device (104). For example, a person may grip the handle (110) and apply a force to remove the electronic device (104) from a blade server chassis.

The handle (110) of FIG. 1A also includes a plurality of cable grips (120) that extend from a position on the handle body (162) between the first and second opposed ends (190) of the handle body (162). A cable grip is a device that is shaped to hold a cable of an electronic device to a handle. Although the cable grips (120) of FIG. 1A are in an ‘L’ shape, this is for explanation and not for limitation. In fact, cable grips may have many different shapes and sizes as will occur to those of skill in the art. Examples of such shapes and sizes include ‘L-shaped’ cable grips with hook and loop straps, such as velcro, that fit through slots on the inside of the handle; circular rings through which the cable may be threaded; evenly spaced prongs; and so as will occur to those of skill in the art.

The plurality of cable grips (120) of the example of FIG. 1 define a cable cavity (150) that is contoured to partially house the cable (106) of the electronic device (104). The shape, configuration, and position of the cable grips (120) determine how the cable (106) is inserted into the cable cavity (150). The plurality of cable grips (120) of FIG. 1 are arranged in a staggered configuration along the length of the handle body (162). In the staggered configuration, at least one of the cable grips (120) is positioned on an opposite side of the cable cavity (150) than at least two of the other cable grips (120). The cable grips (120) of FIG. 1 are positioned on the handle body (162) such that the space between a particular cable grip and the closest cable grip to the particular cable grip on an opposite side of the cable cavity (150) is larger than the diameter of the cable (106). When the plurality of cable grips (120) are in the staggered configuration with sufficient spacing in between each cable grip, the cable (106) may be inserted into the cable cavity (150) by weaving the cable (106) between the plurality of cable grips (120). Because the cable (106) can be inserted into the cable cavity (150) by weaving, the plurality of cable grips (120) may be composed of a material such that the cable grips (120) are non-flexible. Creating non-flexible cable grips (120) may enable the handle body (162) and the cable grips (120) to be composed of a single type of material. The plurality of cable grips (120) and the handle body (162) of FIG. 1, however, may be composed of a variety of different types of materials and may be flexible or non-flexible. Examples of materials useful in composing handle bodies and cable grips according to embodiments of the present invention include plastic, metal, composite materials, and others as will occur to those of skill in the art.

The cable (106) of FIG. 1A includes a plug (130) that is inserted into the electronic device (104). The position on the electronic device (104) that the handle (110) is attached may be selected to reduce the load on the plug (130). A load of the plug (130) may include the weight of the cable (106) and any additional forces that act on the cable (106). Additional forces may be created by other objects or persons pulling or in some way moving the cable (106). The handle (110) of FIG. 1A reduces the load applied to the cable (106) by housing a portion of the cable (106) such that the plug (130) is kept aligned with an outlet of the electronic device (104). In this case, the handle (110) may keep the plug (130) of the cable (106) from becoming disconnected. The position of the handle (110) may determine how much of the load of the cable (106) that the handle (110) is able to minimize. For example, the handle (110) may be positioned such that the cable (106) has a minimum bend radius when the plug (130) is inserted into the electronic device (104) and the cable cavity (150) houses the cable (106). The minimum bend radius of the cable (106) is the radius below which the cable (106) should not be bent. Placing the cable (106) in the minimum bend radius, may result in the smallest distance between the cable (106) and the electronic device (104), thus conserving space. In the example of FIG. 1, the ends (190) of the handle (110) are fastened to the electronic device (104) such that the handle body (162) is positioned to span fan vents (196) of the electronic device (104). By having a handle that reduces the load of the cable (106), the plug (130) of the cable (106) may be kept in place without having to take additional securing measures, such as screwing in the plug (130).

FIG. 1B sets forth an alternative view of the apparatus of FIG. 1A that includes a handle (110) for retaining a cable (104) of an electronic device (104) according to embodiments of the present invention. In the example of FIG. 1B, the handle (110) is illustrated as having a sufficient space between the handle body (162) and the electronic device (104) for a person to grip the handle (110). In this case, the handle (110) is both a grip for moving the electronic device (104) and a mechanism for retaining the cable (106).

FIG. 1C sets forth an alternative view of the apparatus of FIG. 1A that includes a handle (110) for retaining a cable (104) of an electronic device (104) according to embodiments of the present invention. In the example of FIG. 1C, the handle (110) is illustrated as being completely confined within the profile of the electronic device (104), such that the handle (110) does not protrude from the sides of the electronic device (104). In this case, the handle (110) functions as grip for moving the electronic device (104) and a mechanism for retaining the cable (106) without preventing the electronic device (104) from being positioned on its side.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. An apparatus that includes a handle for retaining a cable of an electronic device, the handle comprising:
a handle body that has first and second opposed ends, wherein each end of the handle body is directly fastened to the electronic device; and
a plurality of cable grips that extend from a position on the handle body between the first and second opposed ends of the handle body, wherein the plurality of cable grips define a cable cavity that is contoured to partially house a cable of the electronic device, wherein both ends of the handle body are fastened to the electronic device without allowing a plug of the cable to be fastened to the electronic device at the handle body.

2. The apparatus of claim 1, wherein the plurality of cable grips are arranged in a staggered configuration along the length of the handle body.

3. The apparatus of claim 2, wherein the staggered configuration includes at least one of the cable grips on an opposite side of the cable cavity than at least two the other cable grips.

4. The apparatus of claim 1, wherein the plurality of cable grips are non-flexible.

5. The apparatus of claim 1, wherein the cable is inserted into the cable cavity by weaving the cable between the plurality of cable grips.

6. The apparatus of claim 1, wherein the space between a cable grip and the closest cable grip on an opposite side of the cable cavity is larger than the diameter of the cable.

7. The apparatus of claim 1, wherein the handle body and the plurality of cable grips are plastic.

8. The apparatus of claim 1, wherein the ends of the handle body are fastened to the electronic device such that the handle body spans fan vents of the electronic device.

9. The apparatus of claim 1, wherein the electronic device is a power supply device.

10. The apparatus of claim 1, wherein each of the cable grips are ‘L’ shaped.

11. An apparatus for retaining a cable of an electronic device, the apparatus comprising:
an electronic device;
a handle coupled to the electronic device, wherein the handle includes:
a handle body that has first and second opposed ends, wherein each end of the handle body is directly fastened to the electronic device; and
a plurality of cable grips that extend from a position on the handle body between the first and second opposed ends of the handle body, wherein the plurality of cable grips define a cable cavity that is contoured to partially house a cable of the electronic device, wherein both ends of the handle body are fastened to the electronic device without allowing a plug of the cable to be fastened to the electronic device at the handle body.

12. The apparatus of claim 11, wherein the plurality of cable grips are arranged in a staggered configuration along the length of the handle body.

13. The apparatus of claim 12, wherein the staggered configuration includes at least one of the cable grips on an opposite side of the cable cavity than at least two the other cable grips.

14. The apparatus of claim 11, wherein the plurality of cable grips are non-flexible.

15. The apparatus of claim 11, wherein the cable is inserted into the cable cavity by weaving the cable between the plurality of cable grips.

16. The apparatus of claim 11, wherein the space between a cable grip and the closest cable grip on an opposite side of the cable cavity is larger than the diameter of the cable.

17. The apparatus of claim 11, wherein the handle body and the plurality of cable grips are plastic.

18. The apparatus of claim 11, wherein the ends of the handle body are fastened to the electronic device such that the handle body spans fan vents of the electronic device.

19. The apparatus of claim 11, wherein the electronic device is a power supply device.

20. The apparatus of claim 11, wherein each of the cable grips are ‘L’ shaped.
